(19) United States
(12) Patent Application Publication
(10) Pub. No.: US 2019/0077443 A1
(43) Pub. Date: Mar. 14, 2019

(54) METHOD AND APPARATUS FOR FAIL-SAFE ELECTRIC POWER STEERING

(71) Applicant: MANDO CORPORATION, Gyeonggi-do (KR)

(72) Inventor: Dae Geun CHOI, Gyeonggi-do (KR)

(21) Appl. No.: 16/125,587

(22) Filed: Sep. 7, 2018

(30) Foreign Application Priority Data
Sep. 11, 2017 (KR) 10-2017-0115629

(51) Int. Cl. B62D 5/04; B62D 6/00; B62D 6/10

(52) U.S. Cl. CPC B62D 5/049; B62D 6/10; B62D 6/002; B62D 5/0484

(57) ABSTRACT

The present disclosure relates to an apparatus and method for controlling electric power steering (EPS), and an apparatus for controlling EPS according to an embodiment includes a monitoring unit configured to monitor whether abnormality occurs in a first power being supplied to a first torque sensor, second power being supplied to a second torque sensor, and third power being supplied to a third torque sensor, a selection unit configured to select a torque sensor used to control a quantity of an assist torque of EPS among the first torque sensor, the second torque sensor, and the third torque sensor based on information regarding whether abnormality occurs in the first power, the second power, and the third power, an assist torque controller configured to control the quantity of the assist torque of EPS based on a signal value generated from the selected torque sensor, and a steering angle determination unit configured to determine a steering angle value to be transmitted to an external system based on the information regarding whether abnormality occurs in the first power, the second power, and the third power, wherein the first power also is power being supplied to the steering angle sensor.

### CROSS REFERENCE TO RELATED APPLICATION

This application claims priority from Korean Patent Application No. 10-2017-0115629, filed on Sep. 11, 2017, which is hereby incorporated by reference for all purposes as if fully set forth herein.

### BACKGROUND OF THE INVENTION

### 1. Field of the Invention

The present disclosure relates to an apparatus and method for controlling electric power steering (EPS). More specifically, the present disclosure relates to an apparatus and method for controlling EPS, in which one among three torque sensors and a steering angle sensor use a common source power and monitor abnormality of the source power being input to a sensor, thereby maximally assisting with a driver's steering wheel operation when the abnormality occurs in the source power.

### 2. Description of the Prior Art

These days, the number of electronic functions of cars has gradually increased. Thus, a variety of electronic apparatuses have been installed and used in cars.

In order to control these electronic apparatuses, generally, cars are equipped with electronic control units (ECUs) that receive electrical signals detected by a variety of input sensors and output digital control signals for driving a variety of actuators at output sides of the ECUs.

An electric power steering (EPS) system, which adds and subtracts an operating force of a steering wheel according to the speed of a car using such an ECU, adjusts the quantity of an assist torque by driving of a motor, thereby assisting with a driver's steering wheel operation. EPS includes a torque sensor that measures a difference between a rotational angle of the steering wheel and a rotational angle of a wheel and a steering angle sensor that provides an angle of the steering wheel with respect to a progress direction of the car. The quantity of the assist torque is determined based on signal values from the torque sensor and the steering angle sensor.

However, in the existing EPS, when signal errors occur in the above-described sensors, a motor is driven to stop a function of assisting a driver's handle steering such that the driver has to use his/her own force to steer a handle. Thus, the necessity of an EPS voting system, which supports fail-safe for maintaining a function of assisting with the driver's handle steering using another sensor even though signal errors occur in the above-described sensors, has been increasing. However, in order to provide this system, basically, power to be supplied to the torque sensor and power to be supplied to the steering angle sensor should be separated from each other. Accordingly, the total cost required for establishing EPS has been increasing, and the number of regulators, connector pins, and wires for supplying power has also been increasing. Thus, the full size is increased, and interference with peripheral devices occurs.

### SUMMARY OF THE INVENTION

In this background, the present disclosure is to provide an apparatus and method for controlling electric power steering (EPS), in which one among three torque sensors and a steering angle sensor use a common source power and monitor abnormality of the source power being input to a sensor, thereby maximally assisting with a driver's steering wheel operation even when the abnormality occurs in a source power input to one torque sensor.

To solve the foregoing problem, an embodiment provides an apparatus for controlling EPS including a monitoring unit configured to monitor whether abnormality occurs in first power being supplied to a first torque sensor, second power being supplied to a second torque sensor, and third power being supplied to a third torque sensor, a selection unit configured to select a torque sensor used to control a quantity of an assist torque of EPS among the first torque sensor, the second torque sensor, and the third torque sensor based on information regarding whether abnormality occurs in the first power, the second power, and the third power, an assist torque controller configured to control the quantity of the assist torque of EPS based on a signal value generated from the selected torque sensor, and a steering angle determination unit configured to determine a steering angle value to be transmitted to an external system based on the information regarding whether abnormality occurs in the first power, the second power, and the third power, wherein the first power also is power being supplied to the steering angle sensor.

An embodiment provides a method of controlling EPS, the method including monitoring whether abnormality occurs in first power being supplied to a first torque sensor, second power being supplied to a second torque sensor, and third power being supplied to a third torque sensor, selecting a torque sensor used to control a quantity of the assist torque of EPS among the first torque sensor, the second torque sensor, and the third torque sensor based on information regarding whether abnormality occurs in the first power, the second power, and the third power, controlling the quantity of the assist torque of EPS based on a signal value generated from the selected torque sensor, and determining a steering angle value to be transmitted to an external system based on the information regarding whether abnormality occurs in the first power, the second power, and the third power, wherein the first power also is power being supplied to the steering angle sensor.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a view of a configuration of a conventional apparatus for controlling electric power steering (EPS);

FIG. 2 is a view of a configuration of an apparatus for controlling EPS according to an embodiment; and

FIG. 3 is a flowchart illustrating detailed operations of a method of controlling EPS according to an embodiment.

### DETAILED DESCRIPTION OF THE EXEMPLARY EMBODIMENTS

Hereinafter, embodiments of the present disclosure will be described in detail with reference to the accompanying drawings. In adding reference numerals to elements in each drawing, the same elements will be designated by the same reference numerals, if possible, although the elements are shown in different drawings. Further, in the following description of the present disclosure, a detailed description of known functions and configurations incorporated herein will be omitted when it is determined that the description may make the subject matter of the present disclosure rather unclear.

In addition, when describing elements of the present disclosure, terms, such as first, second, A, B, (a), (b), and the like, may be used. These terms are only used to distinguish one element from another element, and the essence, order, or sequence of a corresponding element is not limited by the terms. It will be understood that when an element is referred to as being “linked to,” “coupled to,” or “connected to” another element, it may be directly on, connected or coupled to another element or intervening elements may be present.

Hereinafter, the present disclosure will be described in detail with reference to the accompanying drawings.

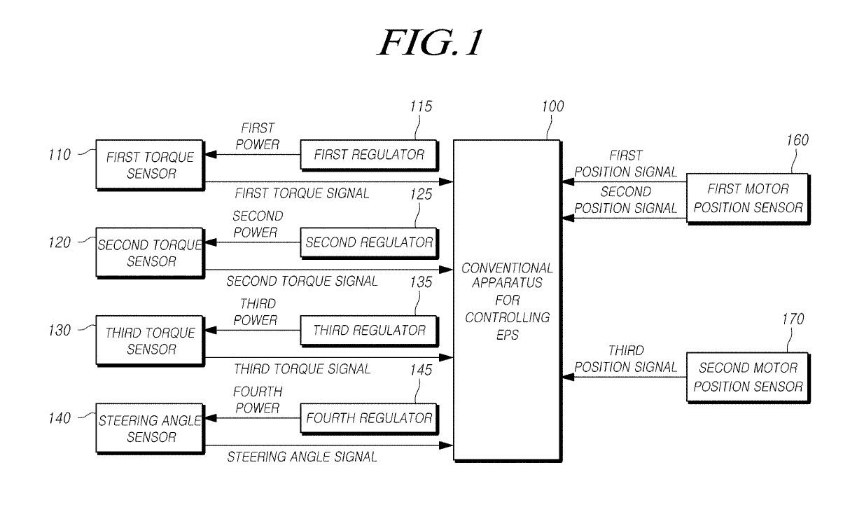

FIG. 1 is a view of a configuration of a conventional apparatus for controlling electric power steering (EPS).

Referring to FIG. 1, a conventional apparatus 100 for controlling EPS may receive a first torque signal, a second torque signal, and a third torque signal from a first torque sensor 110, a second torque sensor 120, and a third torque sensor 130, respectively, and may determine the quantity of an assist torque of EPS based on the received torque signals. The conventional apparatus 100 for controlling EPS may receive three torque signals to support fail-safeness capable of controlling the quantity of the assist torque using another torque sensor even when abnormality occurs in one among the torque sensors. However, the number of the torque sensors of the conventional apparatus 100 for controlling EPS that receive the torque signals is not limited to three, and therefore torque signals may be received from four or more torque sensors. The content of the conventional apparatus 100 for controlling EPS that will be described relates to an operation considering three torque sensors among three or more torque sensors.

The conventional apparatus 100 for controlling EPS according may receive a steering angle signal from a steering angle sensor 140 and may determine a steering angle value to be transmitted to an external system that requires steering angle information based on the received steering angle signal.

In this case, each of the first torque sensor 110, the second torque sensor 120, the third torque sensor 130, and the steering angle sensor 140 receives power from a separate regulator. The regulator refers to a device that adjusts an input voltage and convert the adjusted input voltage into an output voltage to be supplied to another device.

That is, the first torque sensor 110 receives first power from a first regulator 115, and the second torque sensor 120 receives second power from a second regulator 125, and the third torque sensor 130 receives third power from a third regulator 135, and the steering angle sensor 140 receives fourth power from a fourth regulator 145. The reason why each sensor receives power from a separate regulator, is to normally supply power to other sensors even when abnormality occurs in power being input to one sensor so as to support fail-safeness.

The conventional apparatus 100 for controlling EPS may receive a first position signal and a second position signal from a first motor position sensor 160 and may receive a third position signal from a second motor position sensor 170. In the motor position sensor, that is, a sensor for detecting a rotational position of a rotor of a motor for supplying a steering force to a car, when the first motor position sensor 160 and the second motor position sensor 170 operate normally, the first position signal, the second position signal, and the third position signal have signal values with the same content.

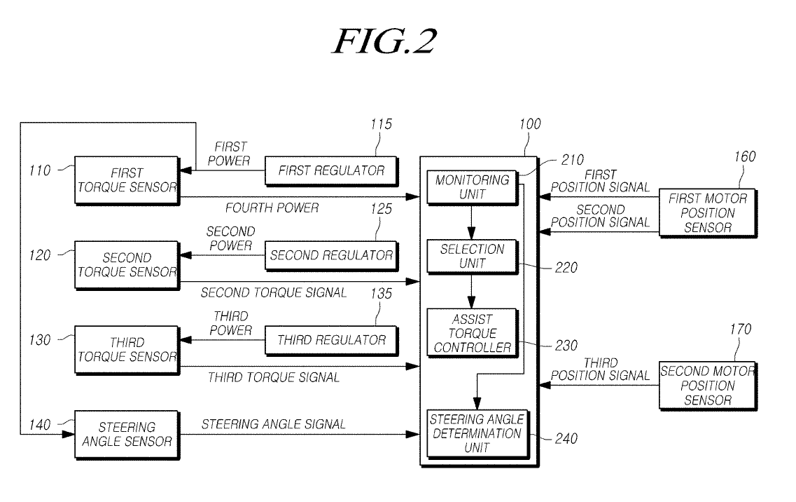

FIG. 2 is a view of a configuration of an apparatus for controlling EPS according to an embodiment.

However, like in the conventional apparatus 100 for controlling EPS described in FIG. 1, the number of torque sensors of the apparatus 200 for controlling EPS that receives torque signals is not limited to three, and therefore, the torque signals may also be received from four or more torque sensors. The content of the apparatus 200 for controlling EPS that will be described is also the content regarding an operation considering three torque sensors among three or more torque sensors. Referring to FIG. 2, unlike in FIG. 1, a first torque sensor 110 and a steering angle sensor 140 may commonly use first power supplied from a first regulator 115. In this case, a fourth regulator 145 provided to supply power to the steering angle sensor 140 may be removed from FIG. 1, and connector pins and wires used for separately supplying power to the steering angle sensor 140 may also be removed. Thus, problems of cost increase and size increase that occur due to establishment of a fail-safe EPS system can be reduced.

However, abnormality may occur in power being supplied to each torque sensor, and in particular, when abnormality occurs in the first power commonly used for the first torque sensor 110 and the steering angle sensor 140, the first torque sensor 110 and the steering angle sensor 140 may not simultaneously perform a normal operation. In particular, because the steering angle information is significant information used to determine the quantity of an assist torque of EPS and used in various external systems, when abnormality occurs in the power being supplied to the steering angle sensor 140, the abnormality may have a serious effect on the car.

Thus, in order to attain the effects of cost reduction and size reduction and ensure a fail-safe function, an apparatus for controlling EPS that monitors abnormality of power being supplied to a sensor and handles the situation, is required.

In the present embodiment, the apparatus 200 for controlling EPS may include a monitoring unit 210, a selection unit 220, an assist torque controller 230, and a steering angle determination unit 240.

The monitoring unit 210 may monitor whether abnormality occurs in the first power being supplied to the first torque sensor 110, the second power being supplied to the second torque sensor 120, and the third power being supplied to the third torque sensor 130. In an example, the monitoring unit 210 may determine that abnormality has occurred in power being supplied when a voltage of the supplying power is reduced to be less than or equal to a predetermined threshold voltage.

The monitoring unit 210 may monitor whether abnormality occurs in each power being supplied periodically at a predetermined time interval and may also perform monitoring only when predetermined conditions are satisfied.

The selection unit 220 may receive information regarding whether abnormality occurs in the first power, the second power and the third power, as described above, from the monitoring unit 210, and may select a torque sensor used to control the quantity of the assist torque of EPS from among the first torque sensor 110, the second torque sensor 120, and the third torque sensor 130 based on the received information.

In an example, in order to control the quantity of the assist torque of EPS, only a signal value received from two torque sensors among the first torque sensor 110, the second torque sensor 120, and the third torque sensor 130 described above may be used. This is because, even when abnormality occurs in one among three torque sensors, a difference between a rotational angle of a steering wheel and a rotational angle of a wheel can be precisely measured by comparing normal signal values of two torque sensors. Thus, the selection unit 220 may select two torque sensors to be used to control the quantity of the assist torque of EPS depending on whether abnormality occurs in the first power, the second power and the third power, as described above.

When all of the first power, the second power, and the third power are in normal states, the selection unit 220 may basically select the first torque sensor 110 and the second torque sensor 120 as torque sensors used to control the quantity of the assist torque of EPS. Even when the car starts driving for the first time, it can be regarded that there is no abnormality in power. Thus, the first torque sensor 110 and the second torque sensor 120 can be basically selected as torque sensors used to control the quantity of the assist torque of EPS.

When abnormality occurs in the third power, the selection unit 220 selects the first torque sensor 110 and the second torque sensor 120 as torque sensors used to control the quantity of the assist torque of EPS except for the third torque sensor 130 to which the third power is supplied.

When abnormality occurs in the second power, the selection unit 220 may select the first torque sensor 110 and the third torque sensor 130 as torque sensors used to control the quantity of the assist torque of EPS except for the second torque sensor 120 to which the second power is supplied.

When abnormality occurs in the first power, the selection unit 220 may select the second torque sensor 120 and the third torque sensor 130 as torque sensors used to control the quantity of the assist torque of EPS except for the first torque sensor 110 to which the first power is supplied.

The assist torque controller 230 may control the quantity of the assist torque of EPS based on a signal value generated from the torque sensor selected by the selection unit 220.

In this case, in order to precisely control the quantity of the assist torque of EPS, not only the signal value generated from the torque sensor but also a steering angle of the steering wheel needs to be precisely calculated. This is because, when there is a big difference between the calculated steering angle and an actual steering angle of the car, the assist torque may be applied to move the steering wheel at an angle different than an angle of the steering wheel to be actually controlled by the driver.

When all of the first power, the second power, and the third power are in normal states or abnormality occurs in the second power or the third power, a signal value generated from the steering angle sensor that uses the first power, is also normal. Thus, the assist torque controller 230 may control the assist torque so that the quantity of the assist torque of EPS is a normal quantity of the assist torque. Here, the normal quantity of the assist torque refers to the quantity of the assist torque determined by a method of determining the quantity of the assist torque used in the existing EPS when values of the torque sensor and the steering angle sensor are normal.

However, when abnormality occurs in the first power being supplied to the steering angle sensor, the signal value generated from the steering angle sensor is reliable. Thus, the quantity of the assist torque of EPS cannot be controlled to be the above-described normal quantity of the assist torque unless the precise steering angle value is derived by a separate method.

In this case, the steering angle value can be calculated using a signal value generated from the motor position sensor instead of the signal value generated from the steering angle sensor. This is because, in the motor position sensor that is a sensor for detecting a rotational position of the rotor of the motor for applying a steering force to the car, the position of the rotor of the motor varies according to a difference of the steering angle. However, when the velocity of the car is less than a predetermined velocity, accuracy of the steering angle calculated by the motor position sensor is considerably lower than the accuracy of the signal value generated from the steering angle sensor so that the steering angle value cannot be calculated using the signal value generated from the motor position sensor.

Thus, when the velocity of the car is less than a predetermined threshold velocity, the assist torque controller 230 may control the assist torque so that the quantity of the assist torque of EPS is less than or equal to a predetermined quantity of a threshold torque instead of controlling the quantity of the assist torque of EPS to be a normal assist quantity. In this case, threshold velocity and a threshold torque quantity may be determined by experimental values, and values thereof may also be zero.

On the other hand, when the velocity of the car is greater than or equal to the predetermined threshold velocity, the assist torque controller 230 may control the assist torque so that the quantity of the EPS assist is the normal assist torque quantity as when all of the first power, the second power, and the third power are in normal states or abnormality occurs in the second power or the third power.

When the assist torque quantity of EPS is limited to be less than or equal to the above-described threshold torque quantity, the driver has to perceive a situation in which the assist torque quantity is limited, when controlling the steering wheel. Thus, the assist torque controller 230 may control the assist torque to transmit a warning message having the content that the assist torque quantity is limited to the external system. In this case, as an example, the external system may be a display device installed in the car or a speaker that outputs voice information.

The steering angle determination unit 240 may receive information regarding whether abnormality occurs in the first power, the second power, and the third power, as described above, from the monitoring unit 210 and may determine a steering angle value to be transmitted to the external system that requires steering angle information, based on the received information.

As described above, when all of the first power, the second power, and the third power are in normal states or abnormality occurs in the second power or the third power, a signal value generated from the steering angle sensor that uses the first power is also normal. Thus, in this case, the steering angle determination unit 240 may determine the steering angle value based on the signal value generated from the steering angle sensor, like in the existing method.

However, when abnormality occurs in the first power, the signal value generated from the steering angle sensor that uses the first power is not reliable. Thus, the steering angle determination unit 240 may determine the steering angle value using the signal value generated from the motor position sensor instead of the signal value generated from the steering angle sensor.

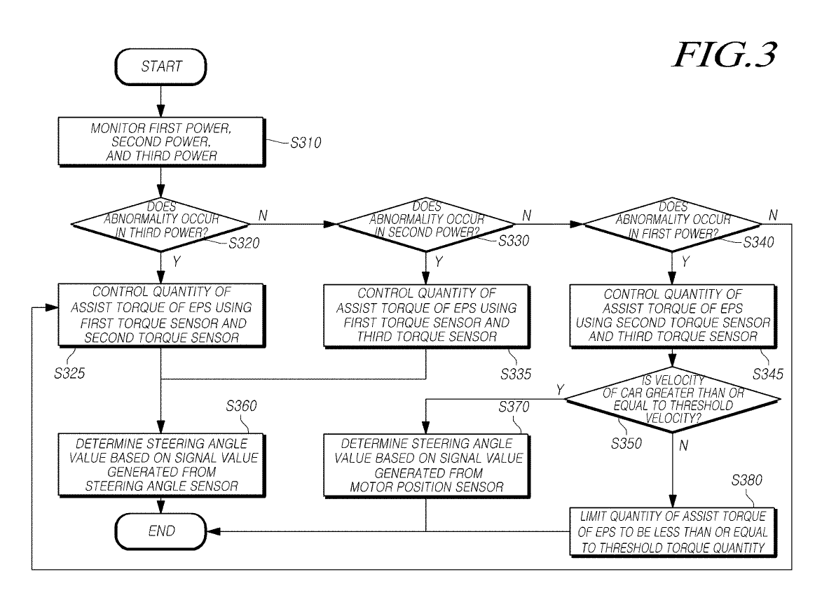

FIG. 3 is a flowchart illustrating detailed operations of a method of controlling EPS according to an embodiment.

Hereinafter, an implementation example of the method using the apparatus 200 for controlling EPS illustrated in FIG. 2 will be described.

Referring to FIG. 3, the monitoring unit 210 of the apparatus 200 for controlling EPS may monitor whether abnormality occurs in the first power being supplied to the first torque sensor, the second power being supplied to the second torque sensor, and the third power being supplied to the third torque sensor (S310).

The selection unit 220 of the apparatus 200 for controlling EPS may select a torque sensor used to control the quantity of an assist torque of EPS from the first torque sensor, the second torque sensor, and the third torque sensor based on information regarding whether abnormality occurs in the first power, the second power, and the third power, which are monitored in Operation S310. The quantity of the assist torque of EPS may be controlled based on the signal value generated from the selected torque sensor.

In detail, first, the selection unit 220 of the apparatus 200 for controlling EPS determines whether abnormality occurs in the third power (S320). When abnormality occurs in the third power (Yes in S320), the apparatus 200 for controlling EPS may select the first torque sensor and the second torque sensor as torque sensors used to control the quantity of the assist torque of EPS and may control the quantity of the assist torque of EPS based on signal values from the first torque sensor and the second torque sensor (S325). In this case, the assist torque controller 230 of the apparatus 200 for controlling EPS may control the assist torque so that the quantity of the assist torque of EPS is the above-described normal assist torque quantity.

When abnormality does not occur in the third power (No in S320), the selection unit 220 of the apparatus 200 for controlling EPS determines whether abnormality occurs in the second power (S330). When abnormality occurs in the second power (Yes in S330), the apparatus 200 for controlling EPS may select the first torque sensor and the third torque sensor as torque sensors used to control the quantity of the assist torque of EPS and may control the quantity of the assist torque of EPS based on signal values from the first torque sensor and the third torque sensor (S335). Even in this case, the assist torque controller 230 of the apparatus 200 for controlling EPS may control the assist torque so that the quantity of the assist torque of EPS is the above-described normal assist torque quantity.

When abnormality does not occur in the second power (No in S330), the selection unit 220 of the apparatus 200 for controlling EPS determines whether abnormality occurs in the first power (S340). When abnormality occurs in the first power (Yes in S340), the apparatus 200 for controlling EPS may select the second torque sensor and the third torque sensor as torque sensors used to control the quantity of the assist torque of EPS and may control the quantity of the assist torque of EPS based on signal values from the second torque sensor and the third torque sensor (S345).

However, when abnormality occurs in the first power, abnormality also occurs in power being supplied to the sensor. Thus, whether the velocity of the car is greater than or equal to a predetermined threshold velocity is determined so as to control the precise quantity of the assist torque of EPS, as described above (S350).

When the velocity of the car is greater than or equal to the predetermined threshold velocity (Yes in S350), a steering angle value to be transmitted to the external system may be determined based on the signal value generated from the motor position sensor, as described above. The assist torque controller 230 of the apparatus 200 for controlling EPS may control the assist torque so that the quantity of the assist torque of EPS is a normal assist torque quantity.

However, when the velocity of the car is less than the predetermined threshold velocity (No in S350), the accuracy of the steering angle value calculated as described above is lowered so that the assist torque controller 230 of the apparatus 200 for controlling EPS may control the assist torque so that the quantity of the assist torque of EPS is limited to be less than or equal to the quantity of a predetermined threshold torque (S380).

When abnormality does not occur in the first power (No in S340), the selection unit 220 of the apparatus 200 for controlling EPS basically selects the first torque sensor and the second torque sensor to perform the above-described Operation S325.

The steering angle determination unit 240 of the apparatus 200 for controlling EPS may determine a steering angle value to be transmitted to the external system depending on whether abnormality occurs in the first power, the second power, and the third power.

In detail, when the method enters Operation S325 or S335, the first power being supplied to the steering angle sensor is in a normal state. Thus, the steering angle determination unit 240 of the apparatus 200 for controlling EPS may basically determine the steering angle value based on the signal value generated from the steering angle sensor (S360). However, when abnormality occurs in the first power being supplied to the steering angle sensor, as described above, when the velocity of the car is greater than or equal to the predetermined threshold velocity (Yes in S350), the steering angle value may be determined based on the signal value generated from the motor position sensor instead of the steering angle sensor (S370).

As described above, even though it has been described that all elements that constitute the embodiments of the present disclosure are coupled as one element or operate while being coupled to one another, the present disclosure is not necessarily limited to the embodiments. That is, all elements may be selectively coupled as one or more elements and may operate while being coupled to one another within the scope of the purposes of the present disclosure.

The above-described embodiments of the present disclosure have been described only for illustrative purposes, and those skilled in the art will appreciate that various modifications and changes may be made thereto without departing from the scope and spirit of the disclosure. Therefore, the embodiments of the present disclosure are not intended to limit, but are intended to illustrate the technical idea of the present disclosure, and the scope of the technical idea of the present disclosure is not limited by the embodiments. The scope of the present disclosure shall be construed on the basis of the accompanying claims in such a manner that all of the technical ideas included within the scope equivalent to the claims belong to the present disclosure.

What is claimed is:

1. An apparatus for controlling electric power steering (EPS), comprising:
a monitoring unit configured to monitor whether abnormality occurs in first power being supplied to a first torque sensor, second power being supplied to a second torque sensor, and third power being supplied to a third torque sensor;
a selection unit configured to select a torque sensor used to control a quantity of an assist torque of EPS among the first torque sensor, the second torque sensor, and the third torque sensor based on information regarding whether abnormality occurs in the first power, the second power, and the third power;
an assist torque controller configured to control the quantity of the assist torque of EPS based on a signal value generated from the selected torque sensor; and
a steering angle determination unit configured to determine a steering angle value to be transmitted to an external system based on the information regarding whether abnormality occurs in the first power, the second power, and the third power,
wherein the first power also is power being supplied to the steering angle sensor.

2. The apparatus of claim 1, wherein, when abnormality occurs in the third power, the selection unit selects the first torque sensor and the second torque sensor as torque sensors used to control the quantity of the assist torque of EPS.

3. The apparatus of claim 1, wherein, when abnormality occurs in the second power, the selection unit selects the first torque sensor and the second torque sensor as torque sensors used to control the quantity of the assist torque of EPS.

4. The apparatus of claim 1, wherein, when abnormality occurs in the first power, the selection unit selects the second torque sensor and the third torque sensor as torque sensors used to control the quantity of the assist torque of EPS.

5. The apparatus of claim 4, wherein, when a velocity of a car is less than a predetermined threshold velocity, the assist torque controller controls the assist torque so that the quantity of the assist torque of EPS is limited to be less than or equal to a predetermined threshold torque quantity.

6. The apparatus of claim 4, wherein, when the velocity of the car is greater than or equal to a predetermined threshold velocity, the assist torque controller controls the assist torque so that the quantity of the assist torque of EPS is a normal assist torque quantity.

7. The apparatus of claim 4, wherein, when the velocity of the car is greater than or equal to a predetermined threshold velocity, the steering angle determination unit determines the steering angle value based on a signal value generated from a motor position sensor instead of the steering angle sensor.

8. A method of controlling electric power steering (EPS), comprising:
monitoring whether abnormality occurs in first power being supplied to a first torque sensor, second power being supplied to a second torque sensor, and third power being supplied to a third torque sensor;
selecting a torque sensor used to control a quantity of an assist torque of EPS among the first torque sensor, the second torque sensor, and the third torque sensor based on information regarding whether abnormality occurs in the first power, the second power, and the third power;
controlling the quantity of the assist torque of EPS based on a signal value generated from the selected torque sensor; and
determining a steering angle value to be transmitted to an external system based on the information regarding whether abnormality occurs in the first power, the second power, and the third power,
wherein the first power also is power being supplied to the steering angle sensor.

9. The method of claim 8, wherein, when abnormality occurs in the third power, the selecting comprises selecting the first torque sensor and the second torque sensor as torque sensors used to control the quantity of the assist torque of EPS.

10. The method of claim 8, wherein, when abnormality occurs in the second power, the selecting comprises selecting the first torque sensor and the second torque sensor as torque sensors used to control the quantity of the assist torque of EPS.

11. The method of claim 8, wherein, when abnormality occurs in the first power, the selecting comprises selecting the second torque sensor and the third torque sensor as torque sensors used to control the quantity of the assist torque of EPS.

12. The method of claim 11, wherein, when a velocity of a car is less than a predetermined threshold velocity, the controlling of the quantity of the assist torque of EPS comprises controlling the assist torque so that the quantity of the assist torque of EPS is limited to be less than or equal to a predetermined threshold torque quantity.

13. The method of claim 11, wherein, when the velocity of the car is greater than or equal to a predetermined threshold velocity, the controlling of the quantity of the assist torque of EPS comprises controlling the assist torque so that the quantity of the assist torque of EPS is a normal assist torque quantity.

14. The method of claim 11, wherein, when the velocity of the car is greater than or equal to a predetermined threshold velocity, the determining of the steering angle value comprises determining the steering angle value based on a signal value generated from a motor position sensor instead of the steering angle sensor.
